(19) United States
(12) Patent Application Publication
(10) Pub. No.: US 2011/0057082 A1
(43) Pub. Date: Mar. 10, 2011

(54) APPLIANCE HOLDER

(76) Inventor: Jennifer Lynn West, Santa Monica, CA (US)

(21) Appl. No.: 12/946,843

(22) Filed: Nov. 15, 2010

Related U.S. Application Data
(63) Continuation-in-part of application No. 11/697,402, filed on Apr. 6, 2007, now Pat. No. 7,832,697.

(51) Int. Cl. F16M 13/02

(52) U.S. Cl. 248/222.14; 248/220.21

(57) ABSTRACT

A holder for an appliance is disclosed. The holder is capable of supporting a variety of conventional hair dryers and permitting the flow of air to be directed in any desired direction while leaving the user's hands free for other purposes. The holder can be configured to be mounted on a surface such as, but not limited to, a wall.

This application claims priority to non-provisional application Ser. No. 11/697,402, dated Apr. 6, 2007, which is incorporated herein in its entirety.

### FIELD OF THE INVENTION

The present invention relates to the field of accessories for holders of appliances, and more particularly to a hair dryer mount capable of supporting a variety of conventional hair dryers and permitting the flow of air to be directed in any desired direction while leaving the user's hands free for other purposes.

### BACKGROUND OF THE INVENTION

Portable hand-held electric blow dryers are widely used devices for drying and styling the hair of users. Such a hair dryer typically includes a heating element, a fan, and means to direct hot air toward the head of a user. Such hair dryers generally have an elongated graspable handle section and a barrel section extending generally perpendicularly with respect to one another from a central section. The user holds the hair dryer by the handle and directs the barrel toward the damp hair so that the warm air impinges on it.

This mode of operation presents several drawbacks. For example, the user's arm may become tired after holding the drier up for a sustained period of time, notwithstanding the fact that commercially available driers are relatively lightweight. Moreover, since the user has to hold the blow drier in one hand adjacent his or her head, this severely limits the user's ability to style his or her hair during the drying operation. Many hair styles require the use of both hands to hold the hair in proper position while it is being combed and brushed so that the desired styling can be achieved. Additionally, it is difficult for a person who does not have full use of his or her arms because of some disability to fully use the conventional blow dryer.

The use of stands and wall mounting devices for blow dryers are known in the art. More specifically, hair drying stands and wall mounted devices heretofore devised and utilized for the purpose of drying hair are known to consist basically of familiar, expected and obvious structural configurations, notwithstanding the myriad of designs encompassed by the crowded prior art which have been developed for the fulfillment of countless objectives and requirements.

Some of the known holders, once the hand-held blow dryer has been fitted therein, do not allow for convenient adjustment of the height and directivity of the barrel. Some of the known holders do allow for adjustment of the height and directivity of the barrel but are difficult to assemble, complicated to use and/or costly to manufacture. Some of the known holders have too much gadgetry, e.g. wing nuts, using unhinging and repositioning of the device in order to obtain different air flow positions. Some of the known holders sit on a table top or counter, taking up valuable space, adding to clutter. Another problem with table top holders is that they do not allow the user to stand and optimally use the bathroom mirror. Some of the known holders use a goose-neck design, which allows a blow dryer to fall should the goose-neck succumb to gravity.

Additionally, some users wishing to save time prefer the option of multi-tasking, e.g. brushing teeth, applying make-up, while a steady stream of well directed air removes excess moisture from the hair, prior to styling the finishing touches. Other problems exist.

There is a need for a wall mounted appliance holder that is more stable and has less cost and complexity.

There is also a need for a wall mounted appliance holder that is more flexible in its use.

There is a need for a wall mounted appliance holder that is able to accommodate a variety of different kinds of blow dryers and which can suspend the blow dryer in any position relative to the user's head.

There is a need for a wall mounted appliance holder where the position of the blow dryer and the direction of the air flow may be easily changed from one position to another without having to disengage the support mechanism, move the blow dryer and then re-engage the mechanism.

There is a need for a wall mounted appliance holder that can be pushed from one position to another without need of adjusting the wall mounted appliance holder and which will stay in the desired position without further adjustment once it is put in place.

Therefore, a need exists for a wall mounted appliance holder with these attributes and functionalities. The wall mounted appliance holder according to embodiments of the invention substantially departs from the conventional concepts and designs of the prior art. It can be appreciated that there exists a continuing need for a new and improved wall mounted appliance holder which can be used commercially. In this regard, the present invention substantially fulfills these objectives.

### BRIEF SUMMARY OF THE INVENTION

The general purpose of the present invention, which will be described subsequently in greater detail, is to provide a wall mounted appliance holder. In particular, the present invention relates to a device that utilizes the principles of an elbow, forearm, wrist, and hand arrangement for adjustable support of a blow dryer. Generally speaking, the present invention permits hands-free drying of the user's hair, thus leaving both hands free of a user during the blow drying process to facilitate the styling of hair, the brushing of teeth, the applying of makeup, and the like.

The present invention also provides an aesthetically pleasing resting position for a blow dryer when it is not in use, saving the user from having to store and retrieve the blow dryer in order to have a neat looking bathroom. The present invention also alleviates the drama of having a running blow dryer placed on a counter top while the user struggles to section her hair and properly position the brush when styling for smoothness.

The present invention uses a combination of pivot members, e.g. press fit ball joints and spring steel snap rings, in order to facilitate ease of use and effectiveness. The ball joints make it easy to maneuver the air flow into a desired position with minimal effort. The spring steel snap rings keep enough tension of the ball joints to make the present invention's use lasting and strong. Additionally, a universal holder positioned at the top of a shaft and having gaskets, e.g. rubber gaskets, to assure a snug form fit, allows for practically any model blow dryer to be securely held in place while simultaneously allowing the user to grasp and remove and replace the blow dryer as needed.

In one embodiment the present invention may be made and assembled in the following steps:
Create a rounded base from plastic dimensioned to be fixed to a wall with fasteners, e.g. concrete screws
Form a round holder on the rounded base with cut out edges elevated from the round holder extending upward at approximately 90 degrees
Form a shaft having a lower ball and an upper ball
Place the lower ball of the shaft in the round holder
Secure the lower ball of the shaft with a spring steel snap ring around the cut out edges
Take a holder, e.g. a U-shaped holder, with a rounded out hollow base with cut out edges and place the U-shaped holder over the upper ball
Secure the U-shaped holder to the upper ball with a spring steel snap ring around the cut out edges of the U-shaped holder
Form U-shaped gaskets dimensioned to fit on the U-shaped holder and having sufficient friction holding characteristics to snugly hold a blow dryer in place.
Press the rubber gaskets onto the U-shaped holder
Check the tension and holding power of the assembly

In one embodiment the wall mounted appliance holder is comprised of means for attachment to a substantially vertical surface, e.g. a wall, means for elbow element pivoting, a means for wrist element pivoting, means for hand element grasping and a forearm element that cooperates with the means for elbow element pivoting, the means for wrist element pivoting and the means for hand element grasping.

In one embodiment, the present invention is comprised of a base mount held stable to a surface, e.g. a wall, with fasteners, e.g., screws, bolts, adhesives, magnets, hook and loop fasteners. The present invention is further comprised of a cup assembly connected to the base mount. The present invention is further comprised of a base-mount ball joint operable to cooperatively engage within the cup assembly. The present invention is further comprised of an arm shaft connected at the lower end of the arm shaft to the base-mount ball joint and held tight with a spring steel snap ring. The present invention is further comprised of a generally U-shaped universal holder dimensioned to hold a handle of a blow dryer. The universal holder cooperates with the arm shaft via a wrist-mount ball joint positioned and secured at the upper end of the arm shaft. The wrist-mount ball joint is held tight with a spring steel snap ring. The present invention is further comprised of a plurality of rubber gaskets disposed on the universal holder to securely hold a blow dryer handle. Rubber gaskets of various dimensions may be used in order to accommodate blow dryer handles of different dimensions.

In some embodiments of the present invention the arm shaft and ball joints may be formed as one piece. In other embodiments of the present invention the arm shaft and ball joints may be formed as separate pieces and dimensioned such that the ball joints may be affixed to the arm shaft.

The present invention pivots and positions in a manner that mimics the operation of a human elbow, forearm, wrist, and hand. A forearm-like arrangement cooperates both with an elbow-like arrangement and a wrist-hand-like arrangement to accomplish this simulation.

In one embodiment the elbow arrangement mounts to a wall using fasteners, e.g. concrete screws; this arrangement provides a first cup assembly, i.e. a socket, for a shaft, i.e. a forearm, which is held securely in place by one or more snap rings, i.e., a spring steel snap ring. The shaft extends upward to second cup assembly, i.e. a wrist, which is also secured with an additional snap ring. The ability of the present invention to grasp a particular blow dryer is augmented by rubber gaskets which fit securely over the top of a U-shaped universal holder, i.e. mimicking a hand with fingers.

The present invention is preferably made from a plastic such as polyurethane with a hardening substance such as glass or POM plastic to achieve the desired characteristics. The present invention may be made from other materials, e.g. brass, polished nickel, in order to provide an array of finishes to match the decor of a particular bathroom. The present invention may be constructed with a different mechanical approach than what is shown in the attached drawings.

One aspect of the present invention to provide a new wall mounted appliance holder which has many of the advantages of the dryer support devices mentioned heretofore and many novel features that result in a new wall mounted appliance holder which is not anticipated, rendered obvious, suggested, or even implied by any of the prior art dryer support devices, either alone or in any combination thereof.

Another aspect of the present invention is that is provides a wall mounted appliance holder which is more flexible in its use.

Another aspect of the present invention is that it provides a hands free wall mounted appliance holder which is easy to install.

Another aspect of the present invention is that it provides a hands free wall mounted appliance holder which is simple and easy to use.

Another aspect of the present invention is that it provides an apparatus for supporting and holding commercially available blow dryers in a multitude of positions adjacent to the user's head to free the user's hands for other purposes.

Another aspect of the present invention is that it provides an apparatus for adjustably supporting commercially available hand-held blow dryers.

Another aspect of the present invention to provide a new wall mounted appliance holder which may be easily and efficiently manufactured and marketed.

Another aspect of the present invention to provide a new wall mounted appliance holder which is of a durable and reliable construction.

Another aspect of the present invention is to provide a new wall mounted appliance holder which is susceptible of a low cost of manufacture with regard to both materials and labor, and which accordingly is then susceptible of low prices of sale to the consuming public, thereby making such handheld dryer support device economically available to the buying public.

Another aspect of the present invention is to provide a new wall mounted appliance holder which provides in the apparatuses and methods of the prior art some of the advantages thereof, while simultaneously overcoming some of the disadvantages normally associated therewith.

Another aspect of the present invention is that it may be made from readily available materials.

These and other features and advantages of the present invention will be presented in more detail in the following specification of the invention and the accompanying figures, which illustrate by way of example the principles of the invention.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention, together with further advantages thereof, may best be understood by reference to the following description taken in conjunction with the accompanying drawings in which:

FIG. 1 illustrates a perspective view of a blow dryer holder, according interior assembly, according to an embodiment of the present invention.

FIG. 2 illustrates a right side plan view of a blow dryer holder, according interior assembly, according to an embodiment of the present invention.

FIG. 3 illustrates a front plan view of a blow dryer holder, according interior assembly, according to an embodiment of the present invention.

FIG. 4 illustrates a top plan view of a blow dryer holder, according interior assembly, according to an embodiment of the present invention.

FIG. 5A illustrates a front plan view of a wall mount interior assembly, according to an embodiment of the present invention.

FIG. 5B illustrates a left side plan view of a wall mount interior assembly, according to an embodiment of the present invention.

FIG. 6A illustrates a front plan view of a wall mount exterior assembly, according to an embodiment of the present invention.

FIG. 6B illustrates a perspective view of FIG. 6A.

FIG. 7A illustrates a top plan view of a U-shaped holder, according to an embodiment of the present invention.

FIG. 7B illustrates a bottom plan view of a U-shaped holder, according to an embodiment of the present invention.

FIG. 8 illustrates a front plan view of a shaft, according to an embodiment of the present invention.

FIG. 9 illustrates a left side sectional plan view of a wall mount assembly with the lower ball joint of a shaft inserted, according to an embodiment of the present invention.

FIG. 10 illustrates a right side sectional plan view of a U-shaped holder with the upper ball joint of a shaft inserted, according to an embodiment of the present invention.

FIG. 11 illustrates a top plan view of a snap ring, according to an embodiment of the present invention.

FIG. 12 illustrates a perspective view of a wall mounted blow dryer holder, according to an embodiment of the present invention.

FIG. 13 illustrates a front plan view of a wall mounted blow dryer holder, according to an embodiment of the present invention.

FIG. 14 illustrates a rear plan view of a wall mounted blow dryer holder, according to an embodiment of the present invention.

FIG. 15 illustrates a left side plan view of a wall mounted blow dryer holder, according to an embodiment of the present invention.

FIG. 16 illustrates a right side plan view of a wall mounted blow dryer holder, according to an embodiment of the present invention.

FIG. 17 illustrates a top plan view of a wall mounted blow dryer holder, according to an embodiment of the present invention.

FIG. 18 illustrates a bottom plan view of a wall mounted blow dryer holder, according to an embodiment of the present invention.

FIG. 19 illustrates an exploded view of a wall mounted blow dryer holder, according to an embodiment of the present invention.

FIG. 20 illustrates a perspective view of a top female element of a wall mounted blow dryer holder, according to an embodiment of the present invention.

FIG. 21 illustrates a side perspective view of another embodiment of a wall mount interior assembly, according to an embodiment of the present invention.

FIG. 22 illustrates a bottom perspective view of FIG. 21.

FIG. 23 illustrates side by side perspective views of the wall mount interior assemblies of FIGS. 21 and 5A.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known operations have not been described in detail so not to unnecessarily obscure the present invention.

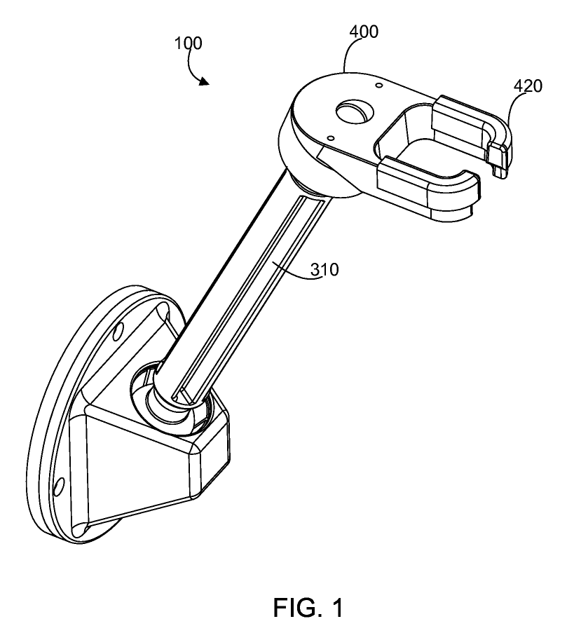

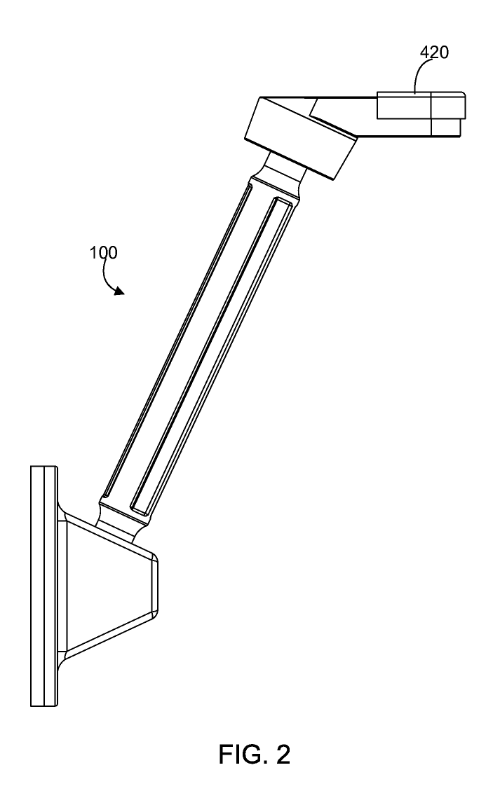

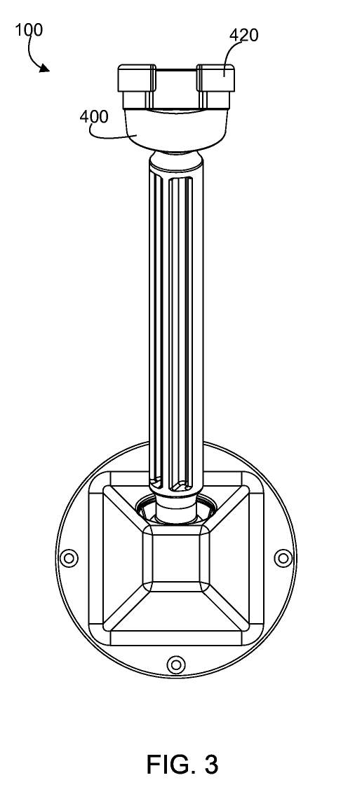

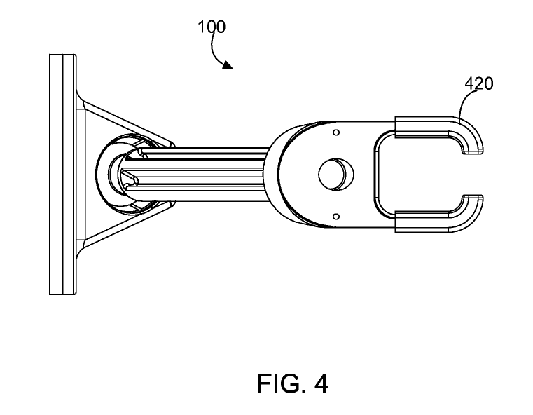

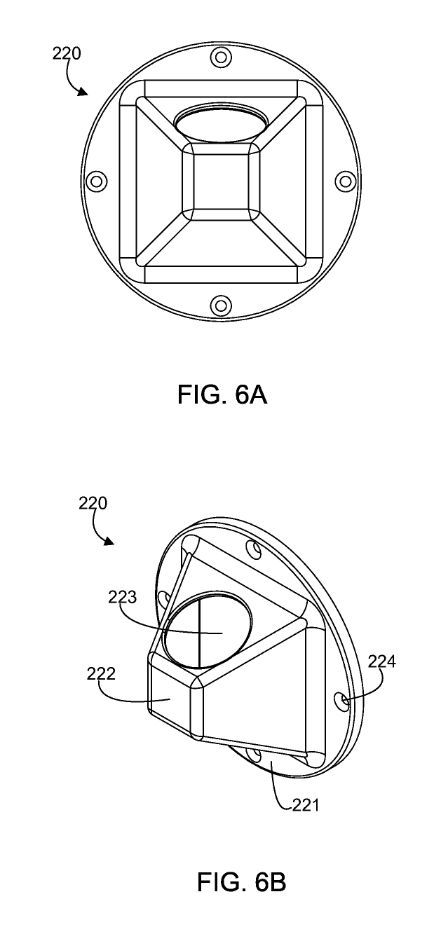

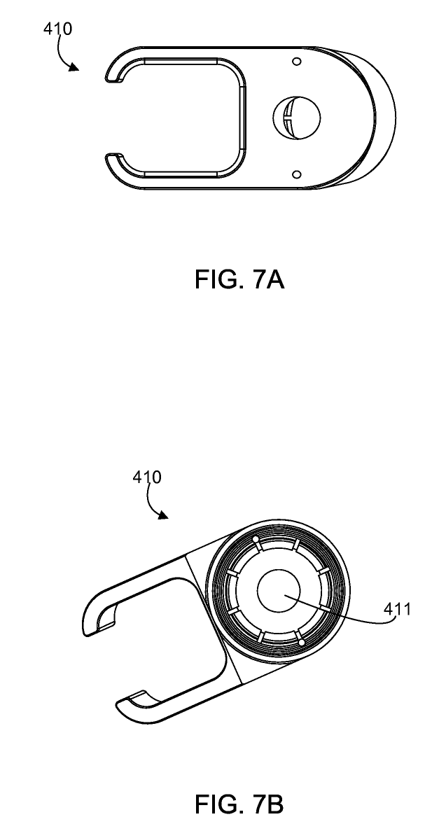

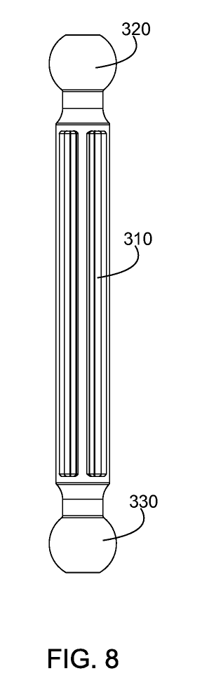

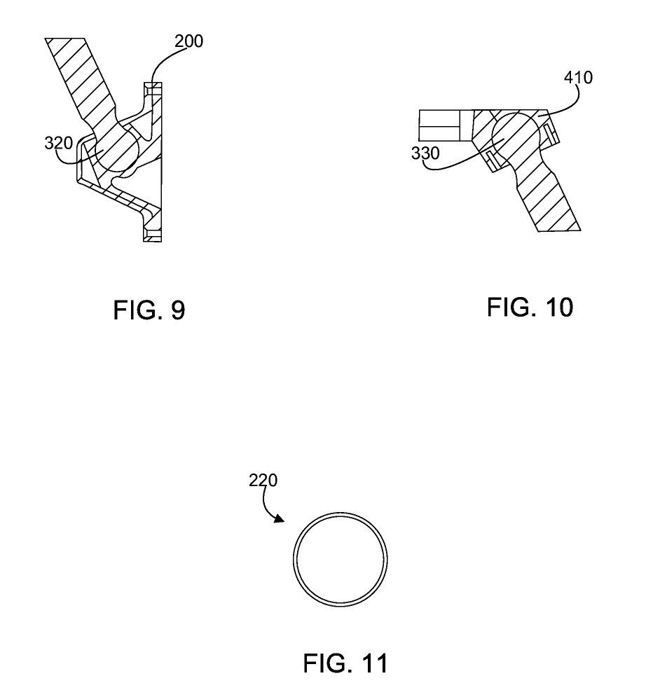

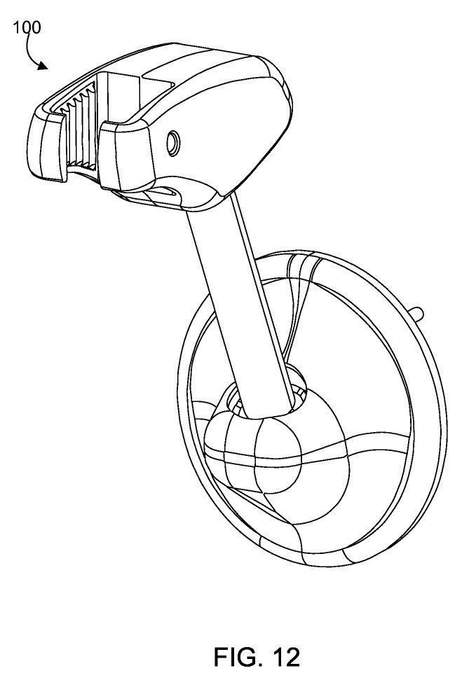

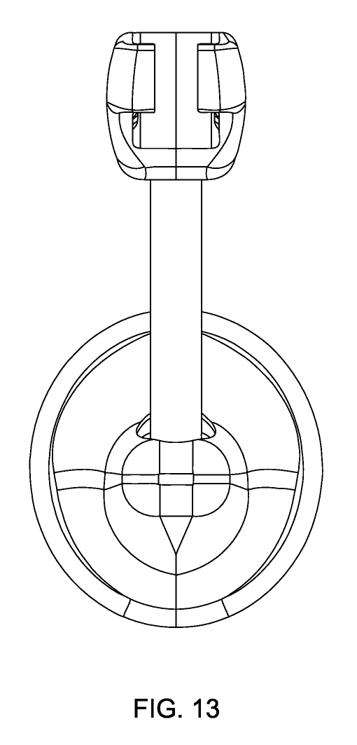

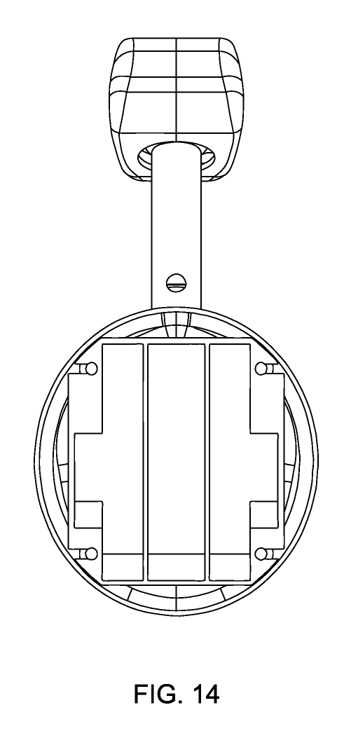

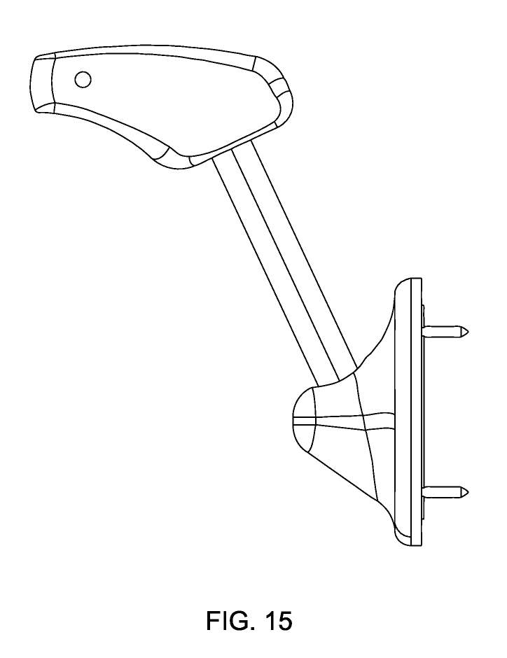

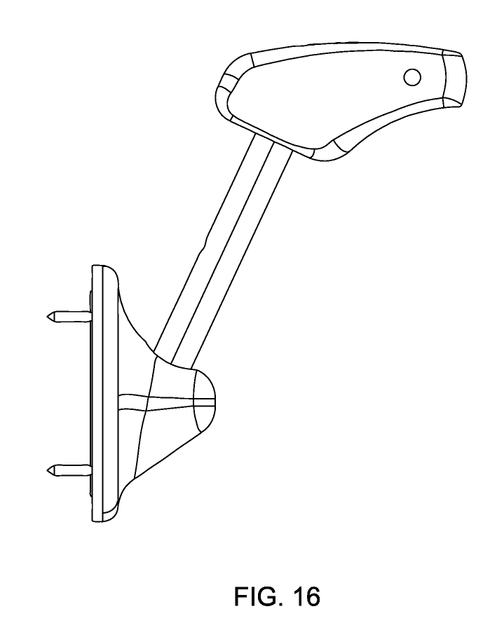

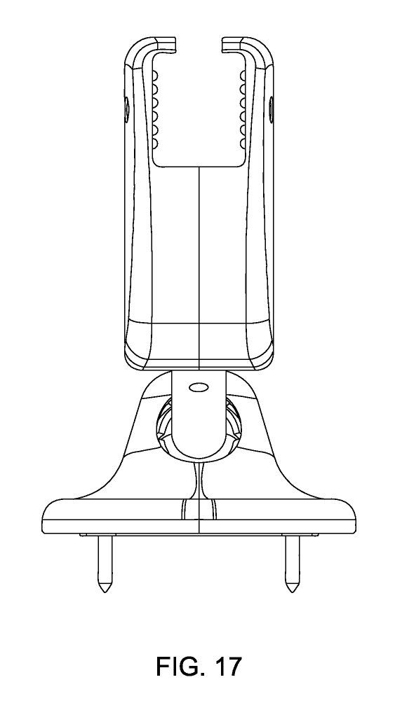

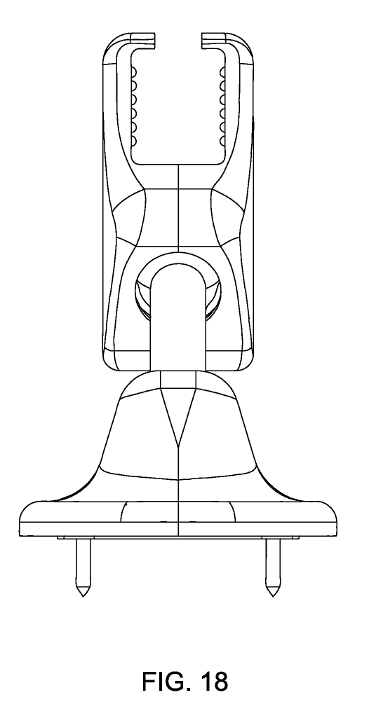

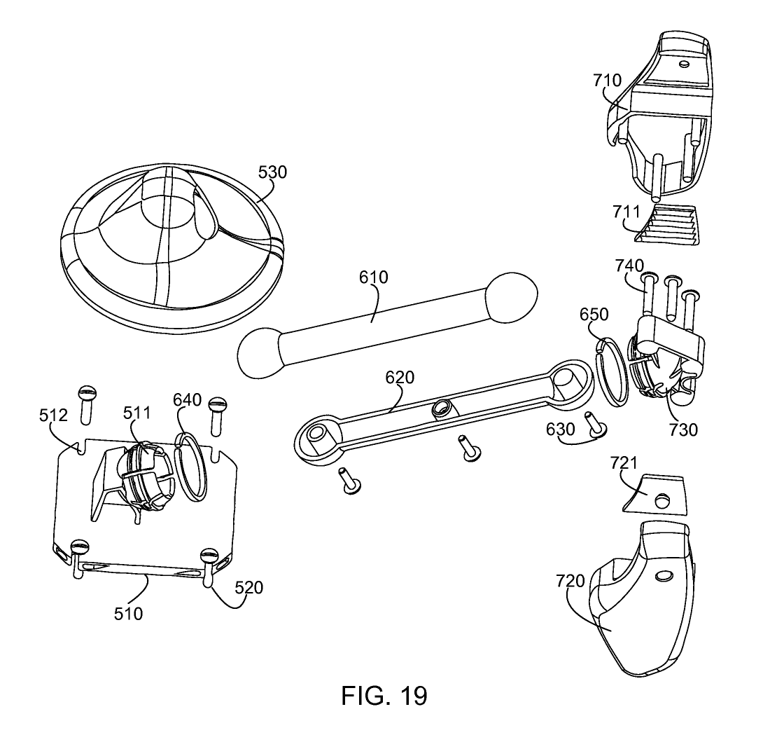

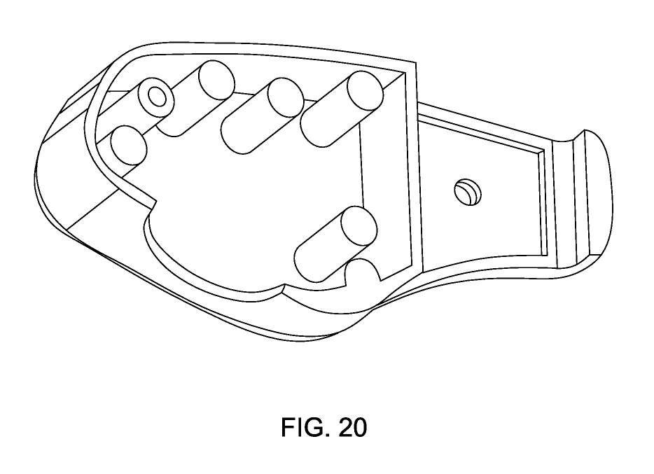

Referring now to FIG. 1 through FIG. 20 in one embodiment, a wall mounted appliance holder 100 is comprised of a wall mount assembly 200, a shaft assembly 300, and an appliance holder assembly 400. The appliance holder assembly 400 is dimensioned for the snug holding of a conventional hand held blow dryer. The shaft assembly 300 cooperates pivotally with the wall mount assembly 200 and the appliance holder assembly 400 to facilitate the positioning of the snuggly held blow dryer to the angle desired by a user.

The shaft assembly is further comprised of a shaft element 310 having a bottom ball joint 320 at the near end of the shaft element 310 and a top ball joint 330 at the distal end of the shaft element 310. The shaft assembly is further comprised of a plurality of snap ring 340.

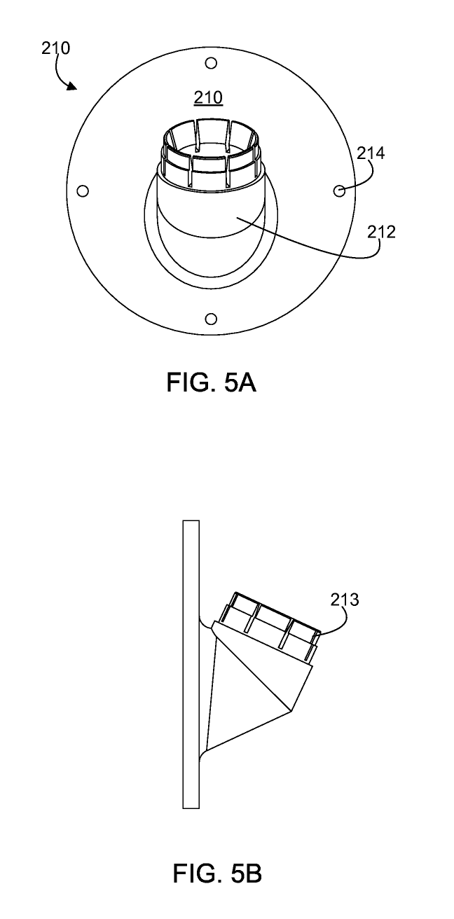

The wall mount assembly 200 is further comprised of a wall mount interior assembly 210 and a wall mount exterior assembly 220. The wall mount interior assembly 210 is further comprised of a wall mount interior base 211, and a bottom ball joint holder 212 having a bottom ball joint holder sleeve 213, formed substantially as illustrated in FIG. 5A and FIG. 5B and dimensioned for the insertion of the bottom ball joint 320. At least one of snap ring 340 securely holds bottom ball joint 320 within bottom ball joint holder 212. The wall mount interior base 211 is further comprised of a plurality of interior base fixture hole 214.

The wall mount exterior assembly 220 is comprised of a wall mount exterior base 221, and an exterior encasement 222 having an exterior encasement hole 223 dimensioned for insertion of the bottom ball joint 320 therein. The wall mount exterior assembly 220 is further comprised of a plurality of exterior base fixture hole 224.

The appliance holder assembly 400 is comprised of a U-shaped holder 410, and a plurality of gasket 420. The U-shaped holder 410 is further comprised of a U-shaped cavity 411 on the bottom side of the U-shaped holder. Within the U-shaped cavity 411 is formed a top ball joint holder 412 having a top ball joint holder sleeve 412, dimensioned for the insertion of top ball joint 330. At least one of snap ring 340 securely holds top ball joint 330 within top ball joint holder 412.

In an exemplary embodiment, a wall mounted appliance holder 100 is comprised of a wall mount assembly, a shaft assembly, and an appliance holder assembly.

The wall mount assembly is further comprised of a wall mount base 510 having a lower socket 511 formed on the non-wall side of the wall mount base 510, a plurality of base fastener holes 512, and a plurality of base fasteners 520. The wall mount assembly 500 is further comprised of a bottom cap 530.

The appliance holder assembly is comprised of a male holder 710 having a male gripper insert 711 affixed. The appliance holder assembly is further comprised of a female holder 720 having a female gripper insert 721 affixed. The appliance holder assembly is further comprised of an upper socket 730 and upper socket fasteners 740 that attach the upper socket 730 to the female holder 720. The male holder 710 is formed to mate securely to the female holder 720.

The shaft assembly is comprised of two halves designed to fit together, a male arm 610 and a female arm 620. Arm fasteners 630 connect the male arm 610 with the female arm 620. The shaft assembly is further comprised of a lower snap ring 640 and an upper snap ring 650. The lower snap ring 640 connects the lower portion of the assembled shaft assembly to the lower socket 511. The upper snap ring 650 connects the upper portion of the shaft assembly to the upper socket 730.

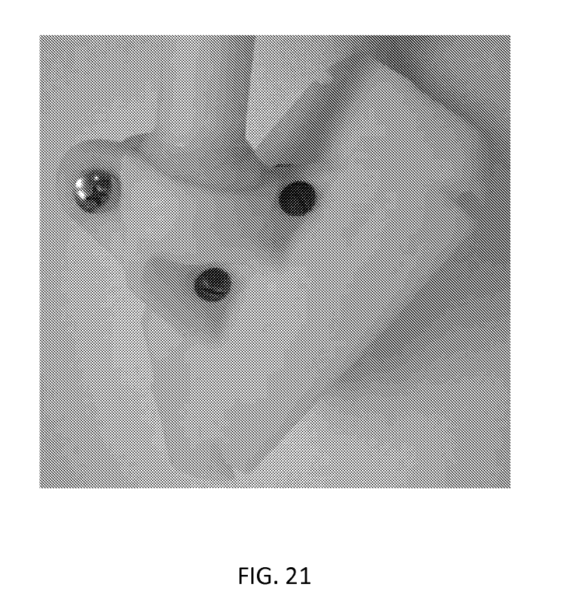

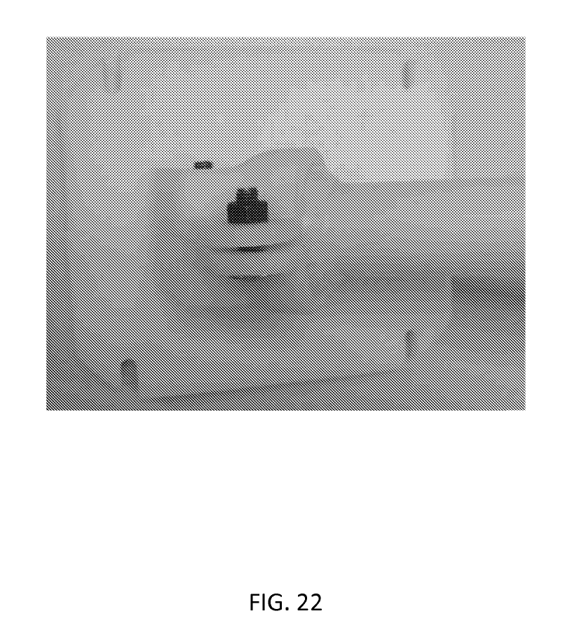

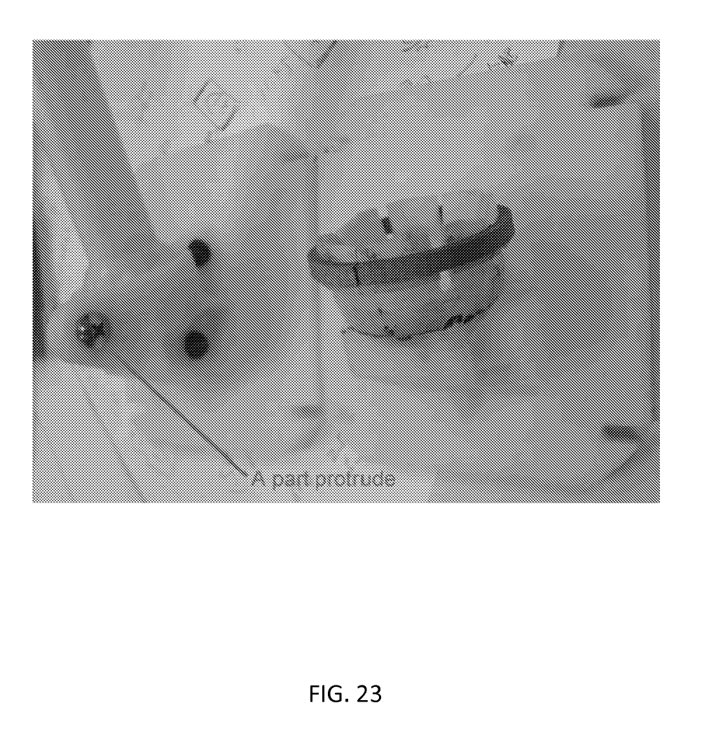

Referring now to FIG. 21 through FIG. 23, a second embodiment of an interior wall mount assembly is shown. The use of an alternate holding structure and fasteners, e.g. lower socket fasteners, as shown, reduce manufacturing costs and complexities while providing secure movement of the shaft assembly.

From the foregoing, it will be appreciated that, although specific embodiments of the invention have been described herein for purposes of illustration, various modifications may be made without deviating from the spirit and scope of the invention. For example, many of the features and components described above in the context of a particular wall mounted appliance holder configuration can be incorporated into other configurations in accordance with other embodiments of the invention. Accordingly, the invention is not limited except by the appended claims.

What is claimed is:

1. A surface mounted appliance system for holding an appliance comprising:
a surface mount assembly for attaching to a surface;
a directional positioning assembly for positioning the appliance; and
an appliance holding assembly for securely holding an appliance;
wherein the directional positioning assembly pivotally cooperates with the appliance holding assembly and the wall mount assembly;
wherein the surface mount assembly is comprised of a bottom cap, a plurality of a wall base fastener and a wall mount base having a wall facing side and a non-wall facing side with a plurality of a base hole disposed therein wherein each base hole is dimensioned to receive one of the wall base fastener, wherein the non-wall facing side has a lower socket disposed formed on the non-wall facing side; and
wherein the appliance holder assembly is comprised of a male holder, a male holder gripper insert affixed to the male holder, a female holder, a female holder insert affixed to the female holder, an upper socket, a plurality of an upper socket fastener connecting the upper socket to the female holder, wherein the female holder and the male holder are configured to connect to each other utilizing lower socket fasteners.

2. The surface mounted appliance system of claim 1, wherein the directional pivoting assembly is comprised of a female arm, a male arm, a plurality of an arm fastener joining the female arm to the male arm to form an arm assembly having a shaft section, a lower ball section, an upper ball section.

3. The surface mounted appliance system of claim 2, wherein the base fastener is a screw.

4. The surface mounted appliance system of claim 3, wherein the upper socket fastener is a screw.

5. The surface mounted appliance system of claim 4, wherein the arm fastener is a screw.

6. The surface mounted appliance system of claim 2, wherein the surface is a substantially vertical wall.

7. The surface mounted appliance system of claim 6, wherein the appliance is a hand-held hair dryer.
